(19) United States
(12) Patent Application Publication
(10) Pub. No.: US 2019/0335691 A1
(43) Pub. Date: Nov. 7, 2019

(54) Aeroponic apparatus

(71) Applicant: Gilad Krakover, Even-Yehuda (IL)

(72) Inventor: Gilad Krakover, Even-Yehuda (IL)

(21) Appl. No.: 15/972,142

(22) Filed: May 5, 2018

(51) Int. Cl. A01G 31/06

(52) U.S. Cl. CPC A01G 31/06; A01G 2031/006

(57) ABSTRACT

The present invention provides an aeroponic plant growing system with improvement in efficiency, performance, and ease of maintenance. In an embodiment of the present invention, the aeroponic system comprises multiple aeroponic units and water cycle components, LED lights, sensors, and control components to support and operate the aeroponic units. Each aeroponic unit comprises a drainage tank to catch water, manifolds and spray nozzles to irrigate the plant clones, and one or more rooting trays. The rooting tray comprises rooting tubes extended from the apertures in which the plant clones are inserted. The rooting tubes are shaped and arranged in a manner such that a rooting tube shares its walls with its neighboring rooting tubes. In one embodiment, the cross section of a rooting tube is shaped as a hexagon with equal sides and multiple rooting tubes are arranged into a honeycomb structure. In certain embodiments, the aeroponic plant growing system further comprises stem collar trays removably fitting on top of the rooting trays. The stem collar trays have openings in which stem collars can be inserted into.

### REFERENCE TO RELATED APPLICATIONS

This is a first-filed application.

### BACKGROUND OF THE INVENTION

### Field of the Invention

The present invention relates to the field of horticultural systems and methods. Particularly, the present invention relates to aeroponics, in which a combination of water, oxygen, and nutrients is provided directly at the root system of a plant.

### Motivation and Description of Related Art

Aeroponics is a method of growing plants where the roots are not contained in a medium such as soil, water baths, or other root bearing substance. In aeroponic growing systems, plants are grown in a closed or semi-closed environment by spraying the plant's roots with water or water-based solution. Aeroponic systems provide many desirable advantages over medium-based growing systems. For example, aeroponic growing increases aeration and delivers more oxygen to plant roots, stimulating growth and helping to prevent pathogen formation. Aeroponics can also limit disease transmission since plant-to-plant contact is reduced. Due to the disease-free environment that is unique to aeroponics, many plants can grow at higher density compared to traditional forms of cultivation such as soil or hydroponics.

Aeroponic systems can be used to support the growth of plants from seed germination or from cuttings. Particularly, this technique has shown great advantages in propagating plants from cuttings, known as cloning. Aeroponics allows the whole process of plant cloning to be carried out in a single, automated unit, by initiating faster and cleaner root development through use of a sterile, highly oxygenated, and moist environment. Aeroponic systems also produce cloned plants with healthier root systems. When aeroponically cloned plants are transplanted into soil, they are not susceptible to wilting and leaf loss or loss due to transplant shock, and they are less likely to be infected with pathogens when placed in the field.

Various aeroponic plant growing systems have been available or have been disclosed. These systems provide varying degrees of success. However, there are also limitations of the currently available aeroponic plant growing systems, including limitations in the ease or efficiency in operation and maintenance, limitations in the density of plants that can be grown, insufficiency in system reliability and effectiveness, and limitations on affordability and portability. Therefore, there is continued need for aeroponic plant growing systems that offer improvement in the aspects mentioned above.

### SUMMARY OF THE INVENTION

The objective of the present invention to provide an aeroponic plant growing system with improvement in efficiency, performance, and ease of maintenance.

In one aspect of an embodiment of the present invention, the aeroponic system comprises multiple aeroponic units. The aeroponic system also comprises water cycle components, sensors, and control components to support and operate the aeroponic units. Each aeroponic unit is illuminated by LED lights placed above the unit. Each aeroponic unit can work independently. For example, the user can choose to turn on or off the water supply and illumination of one aeroponic unit without affecting the operation of the other aeroponic units. The aeroponic system is equipped with an LCD touch screen to display operation status and allow user input. The aeroponic system is also equipped with a network module to allow remote access to the controls and sensors of the system via user devices. The users can get alerts on their user devices when there is a failure in one of the components.

In another aspect of an embodiment of the present invention, each aeroponic unit of the aeroponic system comprises a drainage tank to catch water, manifolds and spray nozzles to irrigate the plant clones, and multiple rooting trays with aperture and rooting tubes. The rooting tray can be used with a stem collar tray and a plurality of stem collars. The stem collar tray removably fits on top of the rooting tray and holds the stem collars. The stems of plant clones are inserted into the stem collars. The plant clones can be conveniently carried and moved with the stem collar tray. When the root systems of the plant clones start to develop, the plant root systems are contained by the rooting tubes extended from the rooting tray.

In another aspect of an embodiment of the present invention, the rooting tubes of the rooting tray are shaped and arranged in a manner such that a rooting tube shares its walls with its neighboring rooting tubes. In one embodiment, the cross section of a rooting tube is shaped as a hexagon with equal sides and multiple rooting tubes are arranged into a honeycomb structure. In this arrangement, there are no gaps between the walls of neighboring rooting tubes, eliminating the difficulty in cleaning small spaces in the gaps during equipment sanitation and allowing high density placement of the plants.

The above invention aspects will be made clear in the drawings and detailed description of the invention.

### BRIEF DESCRIPTION OF THE DRAWINGS

FIG. 1A is a perspective view of the external appearance of an embodiment of the aeroponic system of the present invention.

FIG. 1B is perspective view of the internal layout of the aeroponic system of FIG. 1A, showing the front and right side of the system.

FIG. 1C is another perspective view of the internal layout of the aeroponic system of FIG. 1A, showing the front and left side of the system.

FIG. 2 is a diagram showing functional components of an embodiment of the aeroponic system of the present invention.

FIG. 3 is a diagram showing additional components of an embodiment of the aeroponic system of the present invention.

FIG. 4 is an exploded view showing the internal components of one of the aeroponic units in an embodiment of the aeroponic system of the present invention.

FIG. 5A is a perspective view of an assembly of rooting tray, stem collar tray, and stem collars in an embodiment of the aeroponic system of the present invention.

FIG. 5B is an exploded view of the assembly of rooting tray, stem collar tray, and stem collars of FIG. 5A.

FIG. 6A is a perspective view showing the top of one of the rooting trays in an embodiment of the aeroponic system of the present invention.

FIG. 6B is another perspective view showing the bottom of the rooting tray of FIG. 6A.

FIG. 6C is bottom view of the support tray of FIG. 6A.

### REFERENCE NUMERALS IN THE DRAWINGS

Reference is now made to the following components of embodiments of the present invention:

100 aeroponic system

105 cabinet

110 cabinet door

112 observation window

116 LCD touch screen

118 LED light

120 water reservoir

122 temperature sensor

125 heater/chiller

130 pump

135 pressure sensor

137 pressure sensor

140 inline filter

150 UV sanitizer

160 Power supply

170 supply water lines

172 solenoid valve

174 flow sensor

176 solenoid valve

178 solenoid valve

180 drainage water lines

182 flow sensor

200 aeroponic unit

210 drainage tank

212 manifold

214 spray nozzle

216 inlet

218 outlet

230 supporting frame

250 rooting tray

252 handles

254 base board

255 raised ridge

256 opening

258 rooting tube

260 stem collar tray

270 stem collar

300 central controller

310 water level sensor

320 network module

### DETAILED DESCRIPTION OF THE INVENTION

In the detailed description, numerous specific details are set forth in order to provide a thorough understanding of the invention. However, it will be understood by those skilled in the art that these are specific embodiments, and that the present invention may be practiced also in different ways that embody the characterizing features of the invention as described and claimed herein.

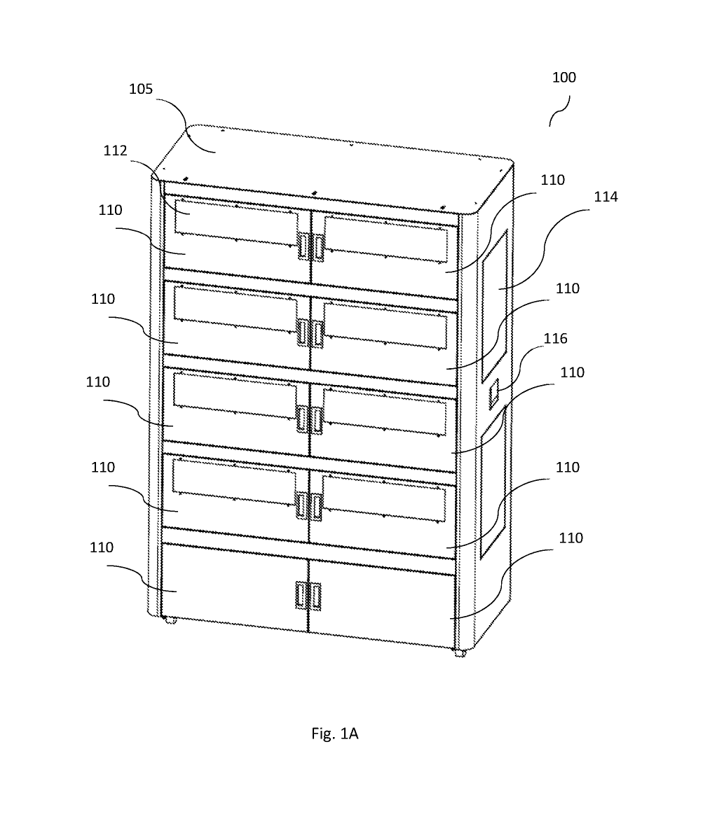

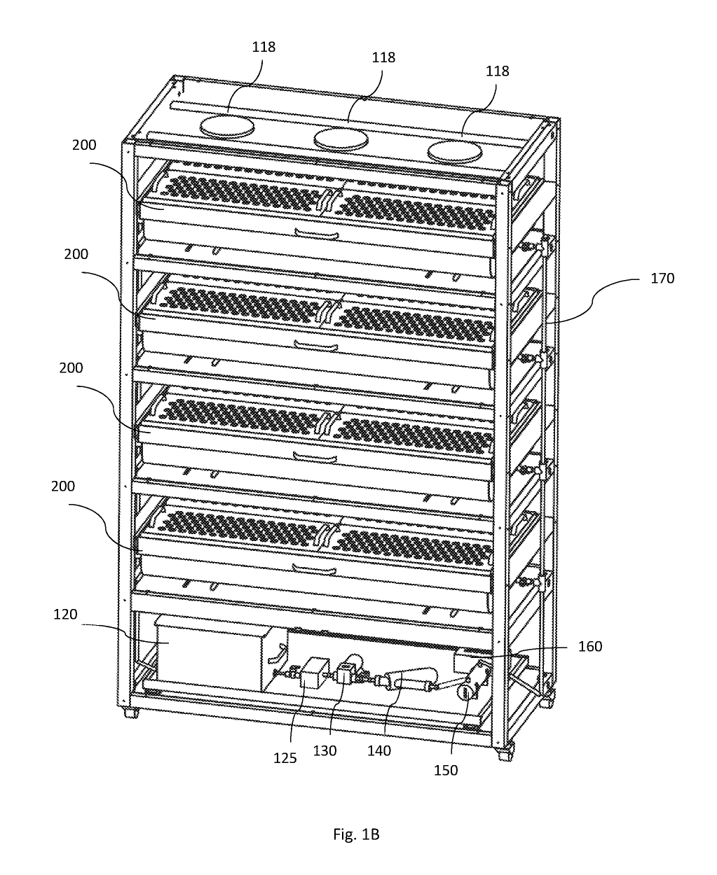

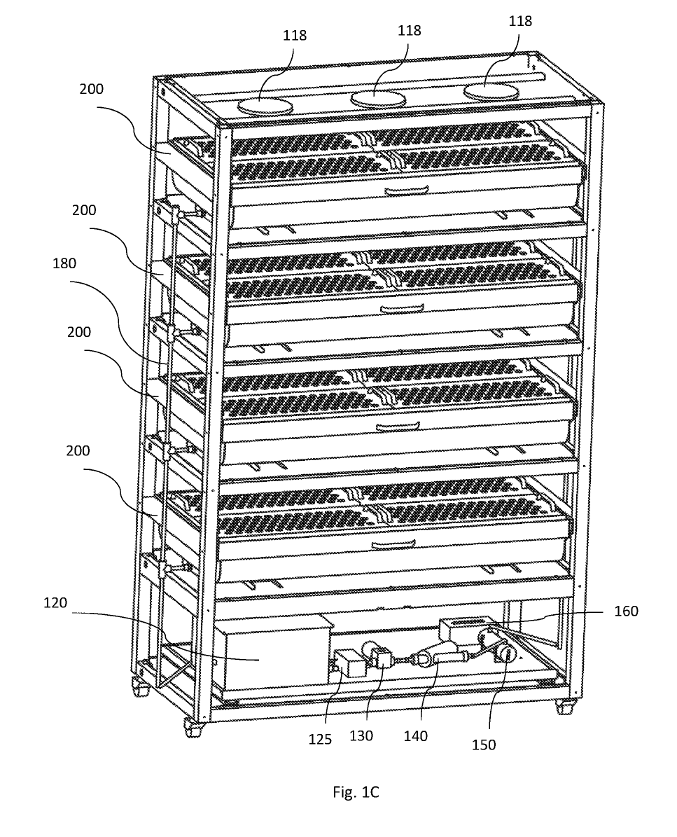

FIGS. 1A-1C show the layout and components of an embodiment of the aeroponic system 100. FIG. 1A is a perspective view of the external appearance the aeroponic system 100. FIGS. 1B and 1C show the internal components of the aeroponic system 100 in two perspective views by removing the external covers. As shown in FIGS. 1A-1C, the aeroponic system 100 comprises multiple tiers of aeroponic units 200 with each aeroponic unit 200 illuminated by LED lights 118 placed above the aeroponic unit 200. The bottom shelf of the aeroponic system 100 contains some of the components including a water reservoir 120, a heater/chiller 125, a pump 130, an inline filter 140, and an ultraviolet (UV) sanitizer 150. The supply water lines 170 send water to each aeroponic unit 200 while the drainage water lines 180 recycle water from each aeroponic unit 200 back to the water reservoir 120. Power supply modules 160 for various components are also placed in the bottom shelf. These aeroponic units 200 and additional components are housed in a cabinet 105 with cabinet doors 110 for access to each aeroponic unit 200 as well as the additional components. There are transparent windows 112 in some of the cabinet doors 110 to observe the status of the aeroponic units 200. On the side panels of the cabinet 105, there are access doors 114 for maintenance purposes. There is a LCD touch screen 116 placed on one of the side panels of the cabinet 105 for operation status information display and user input.

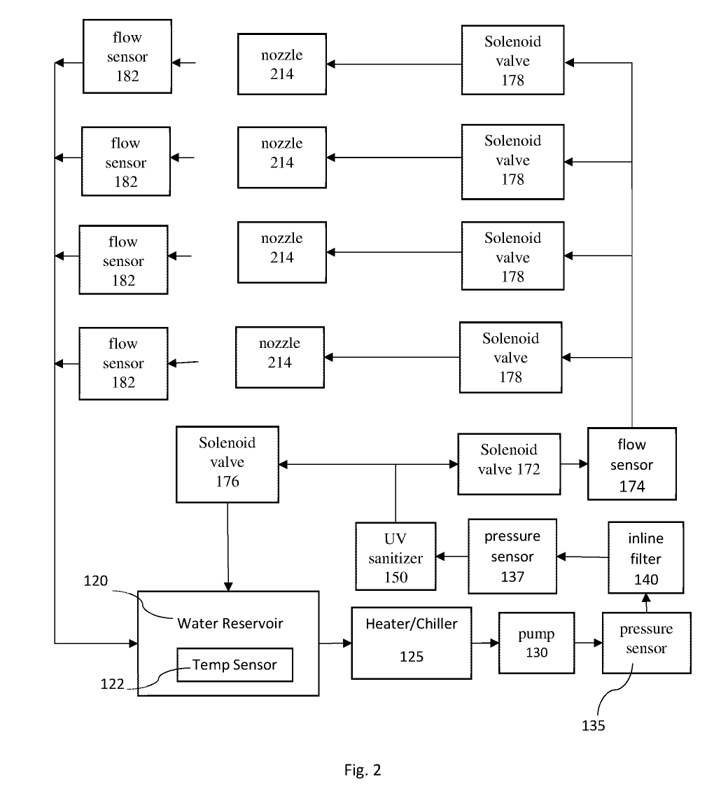

FIG. 2 is a diagram showing functional components of an embodiment of the aeroponic system of the present invention. The water reservoir 120 is coupled with a heater/chiller 125 and temperature sensor 122 to control the water temperature of the system. Water is pumped by the pump 130 and passes through a pressure sensor 135, the inline filter 140, a second pressure sensor 137, and the UV sanitizer 150. The inline filter 140 provides filtration of impurity from the water supply while the UV sanitizer 150 disinfects the water supply. The pressure sensors 135 and 137 are used to monitor the output from the pump 130 and the performance of the inline filter 140. They also use to adjust and control the pump's pressure to guarantee adequate pressure for spaying the water by nozzles at the aeroponic units 200. The output from the UV sanitizer 150 is split into two branches. One branch is controlled by a solenoid valve 178 and connected to the water reservoir 120. This branch is used when the user wants to balance water temperature before inserting plant clones to the system. The other branch is controlled by another solenoid valve 172 and measured by a flow sensor 174. The output from the flow sensor 174 is sent via the supply water lines 170 to the spray nozzles 214 of each aeroponic unit 200. Water drained at each aeroponic unit 200 is measured by flow sensors 182 and collected by the drainage water lines 180 to cycle back to the water reservoir 120.

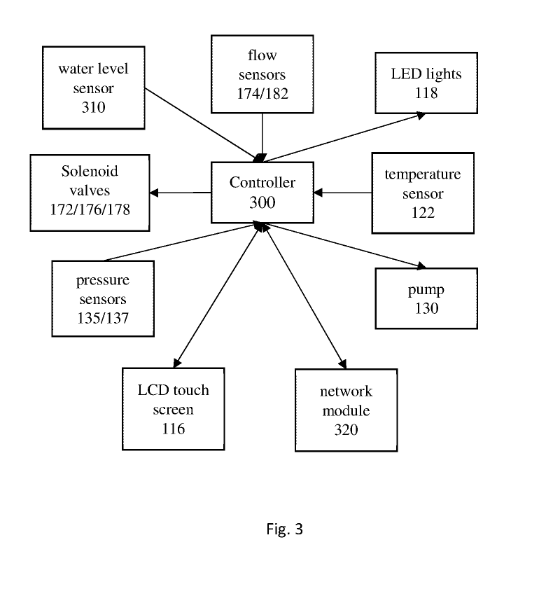

FIG. 3 illustrates additional components of an embodiment of the aeroponic system of the present invention. A central controller 300 receives data from various sensors, including a water level sensor 310 and the temperature sensor 122 placed in the reservoir 120, the flow sensors 174 and 182, and the pressure sensors 135 and 137. It also communicates with the LCD touch screen 116 and a network module 320 which enables remote access to the controller 300 via user devices. The users can get alerts on their user devices (e. g., via sms, email, or message banners) when there is a failure in one of the components or a main power failure. The controller 300 also sends control signals to operate the LED lights 118, the pump 130, the UV sanitizer 150, the heater/cooler 125, and the solenoid valves 172, 176, and 178.

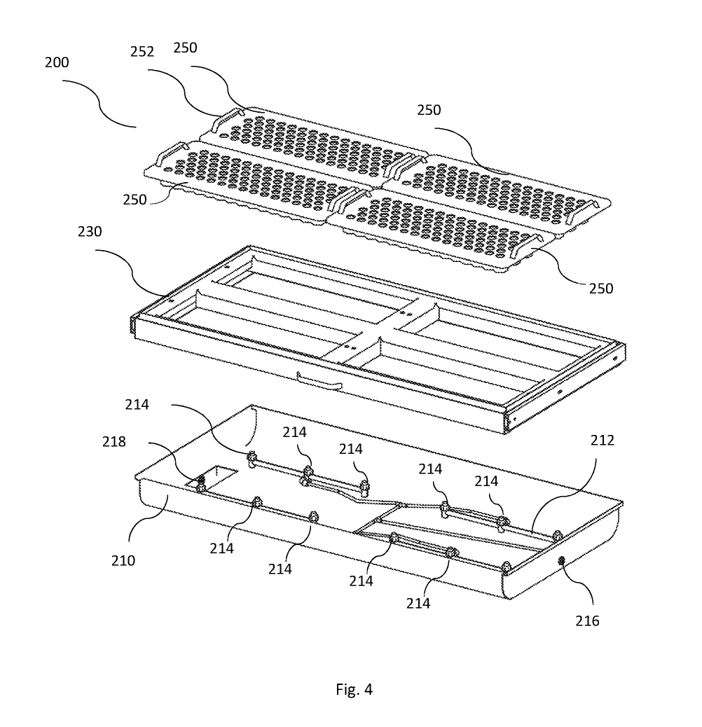

FIG. 4 is an exploded view illustrating one of the aeroponic units 200 of an embodiment of the aeroponic system of the present invention. The aeroponic unit 200 comprises a drainage tank 210, manifolds 212 coupled with spray nozzles 214, a supporting frame 230, and multiple rooting trays 250. The manifolds 212 are fed by the supply water lines 170 through the inlet 216 with cultivation liquid pumped form the water reservoir 120. The nozzles 214 coupled to the manifolds 212 spray water to rooting trays 250, which support the root systems of plant clones. In some embodiments, the rooting tray 250 comprises handles 252 that allow the user to conveniently carry and move the rooting tray 250. The drainage tank 210 catches water and is connected to the drainage water lines 180 through the outlet 218 to cycle water back to the water reservoir 120.

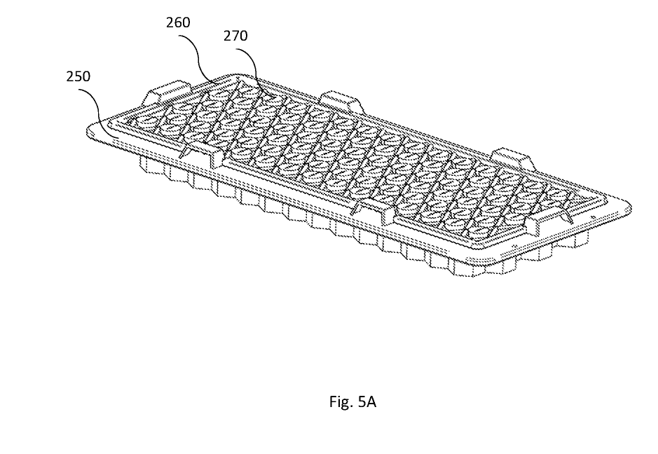

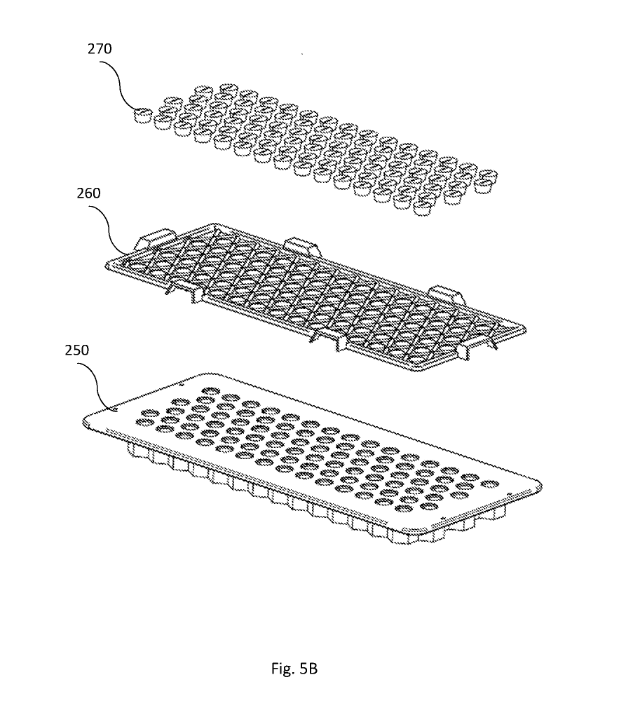

FIGS. 5A and 5B demonstrate the use of the rooting tray 250 in an embodiment of the present invention. The rooting tray 250 can be used with a stem collar tray 260 and a plurality of stem collars 270. Essentially, the stem collar tray 260 removably fits on top of the rooting tray 250. A plurality of stem collars 270 can be inserted into and held by the apertures in the stem collar tray 260. (In an alternative configuration, the stem collars 270 are inserted into and held by the rooting tray 250 directly.) The stems of plant clones are inserted into and held by the stem collars 270. When the root systems of the plant clones start to develop, the root systems are supported by the rooting tray 250 and exposed to the cultivation liquid sprayed from the nozzles 214.

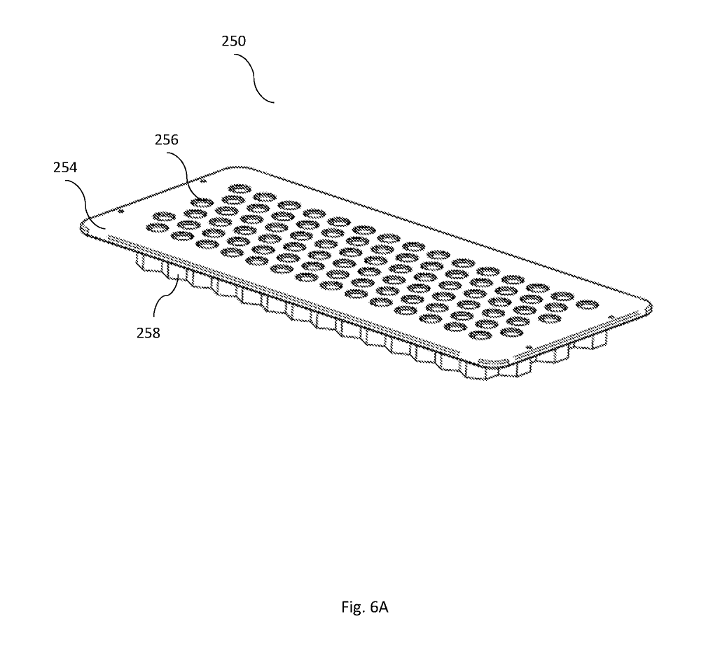

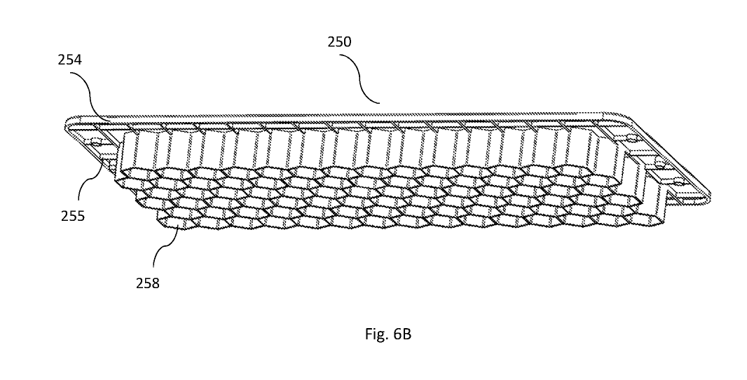

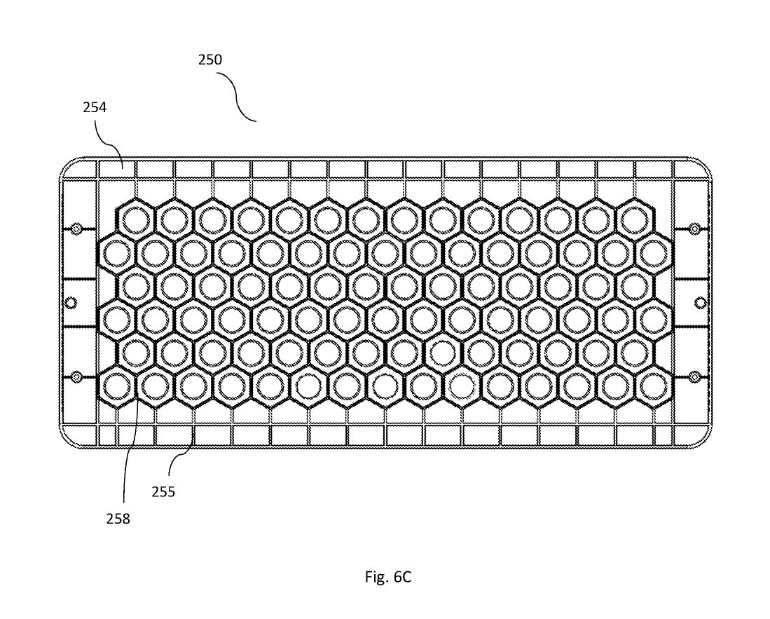

FIGS. 6A-6C show the detailed structure of an embodiment of the rooting tray 250. The rooting tray 250 comprises a base board 254 as the supporting structure, a multitude of openings 256 to receive the stems and roots of plant clones, and rooting tubes 258 extended vertically from the openings 256. The rooting tubes 258 support and contain the plant root systems. The base board 254 comprises a grid of raised ridges 255 to mechanically reinforce the base board 254 without significantly adding weight and material. In addition, as shown in FIG. 4, certain embodiments of the rooting tray 250 comprises handles 252 for convenient carrying and moving.

In a preferred embodiment, the openings 256 are circular in shape so that the stem collars 270 can be inserted into and held by the rooting tray 250 directly. This offers an alternative configuration from FIGS. 5A and 5B. This arrangement ensures that the stem collars 270 are securely fit into the openings 256. The rooting tubes 258 are located under the openings 256 and are integrated with the base board 254. These rooting tubes 258 provide support and separation of the plant roots. Effective root separation prevents the roots of neighboring plants from entangling and merging, and therefore is an import factor for constructing a compact and efficient aeroponic system with high plant density.

In a preferred embodiment, the openings 256 are arranged and the rooting tubes 258 are shaped in a manner such that a rooting tube shares its walls with its neighboring rooting tubes 258. For example, in the embodiment as shown in FIGS. 6A-6C, the cross section of a rooting tube 258 is shaped as a hexagon with equal sides and multiple rooting tubes are arranged in to a honeycomb shaped structure. In this arrangement, there are no gaps between the walls of neighboring rooting tube 258, eliminating the difficulty in cleaning small spaces in the gaps during equipment sanitation.

The foregoing description and accompanying drawings illustrate the principles, preferred or example embodiments, and modes of assembly and operation, of the invention; however, the invention is not, and shall not be construed as being exclusive or limited to the specific or particular embodiments set forth hereinabove.

What is claimed is:

1. An aeroponic plant growing system, comprising:
a reservoir for storing liquid;
a pump configured to pump liquid from the reservoir;
at least one power source;
at least one pipe connected to the pump to distribute liquid;
at least one manifold having one or more output openings, the at least one manifold configured to receive liquid distributed by the at least one pipe;
one or more spray nozzles, each spray nozzle connected to an output opening of the at least one manifold;
at least one tank for catching and holding liquid from the one or more spray nozzles;
at least one pipe connected to the tank to recycle liquid back to the reservoir;
at least one rooting tray, each rooting tray comprising
an essentially flat structure,
a plurality of openings in the essentially flat structure,
a plurality of rooting tubes connected to the underside of the essentially flat structure, each rooting tube connected to one of the openings in the essentially flat structure, and the plurality of rooting tubes arranged so that each rooting tube shares its wall with at least one neighboring rooting tube.

2. The aeroponic plant growing system according to claim 1, wherein each of the plurality of rooting tubes of the rooting tray has a hexagonal cross section, and the plurality of rooting tubes are arranged to form a honeycomb shaped structure.

3. The aeroponic plant growing system according to claim 1, wherein each of the plurality of openings or the rooting tray has a circular cross section, so that an upside down truncated-cone-shaped stem collar can be fit into each of the plurality of openings.

4. The aeroponic plant growing system according to claim 1, further comprising one or more lighting components configured to provide illumination for plant growth.

5. The aeroponic plant growing system according to claim 5, wherein the one or more lighting components are LED lights.

6. The aeroponic plant growing system according to claim 1, further comprising an inline filter configured to purify liquid being distributed to the at least one manifold.

7. The aeroponic plant growing system according to claim 1, further comprising a UV light sanitizer configured to disinfect liquid being distributed to the at least one manifold.

8. The aeroponic plant growing system according to claim 1, further comprising:
a control unit; and
a user terminal configured to accept user inputs;
wherein the control unit is configured to receive user inputs from the user terminal.

9. The aeroponic plant growing system according to claim 8, further comprising a heating and/or cooling element configured to adjust the temperature of the liquid distributed by the at least one pipe, wherein the operation of the heating and/or cooling element can be controlled by the control unit.

10. The aeroponic plant growing system according to claim 8, further comprising one or more solenoid valves configured to adjust the liquid distributed to the at least one manifold, wherein the one or more solenoid valves can be controlled by the control unit.

11. The aeroponic plant growing system according to claim 8, further comprising one or more flow sensors configured to measure the flow of the liquid being distributed by the one or more pipes, wherein the control unit can read measurement data from the one or more flow sensors.

12. The aeroponic plant growing system according to claim 8, further comprising one or more pressure sensors configured to measure the pressure of the liquid being distributed by the one or more pipes, wherein the control unit can read measurement data from the one or more pressure sensors.

13. The aeroponic plant growing system according to claim 8, further comprising a water level sensor placed in the reservoir and configured to measure the liquid level in the reservoir, wherein the control unit can read measurement data from the water level sensor.

14. The aeroponic plant growing system according to claim 8, further comprising a temperature sensor configured to measure the temperature of the liquid in the reservoir or liquid being distributed by the at least one pipe, wherein the control unit can read measurement data from the temperature sensor.

15. The aeroponic plant growing system according to claim 8, wherein the user terminal comprises an LCD touch screen configured to also display operational information of the aeroponic plant growing system, the operational information comprising at least one of: liquid level in the reservoir, liquid temperature, liquid flow, and liquid pressure.

16. The aeroponic plant growing system according to claim 8, wherein the control unit is configured to control the operation of the pump.

17. The aeroponic plant growing system according to claim 8, further comprising a network module in communication with both the control unit and a network, wherein the network module is configured to facilitate communication between the control unit and a user device through the network.

18. The aeroponic plant growing system according to claim 17, wherein the network module is configured to send alert messages to the user device when one or more system failures occur, the one or more system failures comprising a main power failure.

19. The aeroponic plant growing system according to claim 1, further comprising at least one stem collar tray removably fitting on top of the at least one rooting tray, the stem collar tray having a plurality of openings in which upside-down truncated-cone-shaped stem collars can be inserted into.
